(19) United States
(12) Patent Application Publication
(10) Pub. No.: US 2009/0198443 A1
(43) Pub. Date: Aug. 6, 2009

(54) IN-VEHICLE NAVIGATION DEVICE AND PARKING SPACE GUIDING METHOD

(75) Inventor: Noboru Yamazaki, Iwaki-city (JP)

Correspondence Address: ALPINE/BHGL, P.O. Box 10395, Chicago, IL, 60610, US

(73) Assignee: Alpine Electronics, Inc., Tokyo (JP)

(21) Appl. No.: 12/361,862

(22) Filed: Jan. 29, 2009

(30) Foreign Application Priority Data
Feb. 4, 2008 (JP) 2008-023668

(51) Int. Cl. G01C 21/36

(52) U.S. Cl. 701/210; 701/209

(57) ABSTRACT

An in-vehicle navigation device includes a display unit, a storage unit which stores detailed map data of a shopping mall, a position detection unit which detects the current position of a vehicle, and a control unit which, when the destination is set to a facility in the shopping mall, detects a parking section close to the facility as a recommended parking section, and which, when the vehicle is determined to have entered and left the recommended parking section, provides, via the display unit, guidance advising the return of the vehicle to the recommended parking section. When the vehicle is determined to have entered the shopping mall, the control unit may display a detailed map of the shopping mall on a display screen of the display unit, and may display the recommended parking section in a different manner from the manner in which the other parking sections are displayed.

### RELATED APPLICATIONS

The present application claims priority to Japanese Patent Application Number 2008-023668, filed Feb. 4, 2008, the entirety of which is hereby incorporated by reference.

### BACKGROUND OF THE INVENTION

1. Field of the Invention

The present invention relates to an in-vehicle navigation device and a parking space guiding method for guiding a vehicle to a destination along a guide route, particularly to an in-vehicle navigation device and a parking space guiding method capable of guiding a vehicle to an appropriate parking space when the destination is set to a facility in a shopping mall.

2. Description of the Related Art

A typical existing in-vehicle navigation device includes a control device, a storage device, a display device, a detection device, and so forth. The control device includes, for example, a CPU (Central Processing Unit) which controls all processes relating to a navigation operation. The storage device includes, for example, a DVD-ROM (Digital Versatile Disk Read-Only Memory) and an IC (Integrated Circuit) memory card, in which map data has previously been stored. The detection device includes, for example, a GPS (Global Positioning System) receiver, a gyroscope, and a vehicle speed sensor, which detect the current position and direction of a vehicle. The control device reads from the storage device the map data including the current position of the vehicle. On the basis of the map data, the control device displays a map image of the surroundings of the vehicle position on a screen of the display device. Further, the control device superimposes and displays, on the map image, a vehicle position mark indicating the current position of the vehicle, scroll-displays the map image in accordance with the movement of the vehicle, and moves the vehicle position mark on the map image fixed on the screen. Thereby, where the vehicle is currently traveling can be seen at a glance.

Further, the in-vehicle navigation device normally has a function of guiding a user so that the user can easily drive the vehicle to the destination without taking a wrong road (a route guiding function). According to the route guiding function, the CPU searches for an optimal route connecting the departure point (typically, the current position of the vehicle) and the destination by performing simulation calculation according to the breadth-first search method, the Dijkstra Method, or the like with the use of the map data. Then, the CPU stores the searched for route as a guide route, and displays the guide route on the map image during vehicle travel such that the guide route can be distinguished from the other roads (by using a different color or thickening the line width, for example). Further, when the vehicle reaches a point away, by a predetermined distance, from an intersection at which the vehicle should change the course on the guide route, the CPU displays on the map image a guide map of the intersection (including an enlarged view of the intersection, an arrow indicating the direction of travel at the intersection, the distance to the intersection, and the name of the intersection, for example). Thereby, the user can know which road to take and which direction to go at the intersection.

As described above, the navigation device searches for the guide route to the specified destination. However, if the specified destination is a shop in a large complex facility such as a shopping mall, the guide route is normally set to extend to an entrance of the shopping mall, and only a moving vehicle mark is displayed after the entry of the vehicle into the shopping mall, such as either an outdoor or indoor parking lot or area associated with the shopping mall. This is because a shopping mall is a collection of many shops, movie theaters, other facilities, and parking lots, and the entirety of the shopping mall is regarded as one facility in the map data. Therefore, inconvenience arises in that, after the entry of the vehicle into the shopping mall, the user does not know which way to go to get to a desired shop.

As a technique for eliminating the above-described inconvenience, Japanese Unexamined Patent Application Publication No. 2001-235342 describes a display technique enabling a user to easily recognize the location of a desired shop, facility, parking lot, or exit in a shopping mall when a vehicle enters the shopping mall, such as a parking or other area associated with the shopping mall.

As described above, the technique of displaying a detailed map of the interior of a shopping mall when a vehicle enters the shopping mall has been developed to enable the recognition of the location of a desired shop. Further, another technique is under development which may perform, on the basis of the specification of the intended shop, route guidance to a parking space near the shop. According to the technique, it may be possible to go to the destination without getting lost in a large shopping mall.

However, even if the vehicle arrives near the intended shop on the basis of the route guidance and enters a nearby parking lot, the parking lot is not always available for parking the vehicle. As a result, the vehicle may move around in the parking lot in search for a parking space and may be parked at a site far from the intended shop. In this case, even if the map of the interior of the shopping mall is displayed when the vehicle enters the shopping mall or associated area, the parking location of the vehicle is far from the intended shop. Therefore, it takes times to go to and from the shop, and it is difficult to grasp the directions to the shop. Consequently, the risk of an accident with another vehicle may be increased.

### SUMMARY OF THE INVENTION

The present invention may provide an in-vehicle navigation device and a parking space guiding method capable of guiding a vehicle to an appropriate parking space when the destination is set to a facility in a shopping mall.

According to an exemplary embodiment, an in-vehicle navigation device may have a function of searching for a route to a destination and guiding a vehicle along the route, and includes a display unit, a storage unit, a position detection unit, and a control unit. The storage unit may store detailed map data of a shopping mall. The position detection unit may detect the current position of the vehicle. When the destination is set to a facility in the shopping mall, the control unit may detect a parking section close to the facility as a recommended parking section. Further, when the vehicle is determined to have entered and left the recommended parking section on the basis of the current position of the vehicle and the map data, the control unit may provide, via the display unit, guidance advising the return of the vehicle to the recommended parking section.

In the in-vehicle navigation device according to the embodiment, when the vehicle is determined to have entered the site of the shopping mall on the basis of the detected current position of the vehicle and the map data, the control unit may display a detailed map of the shopping mall on a display screen of the display unit, and may display the recommended parking section in a predetermined manner. Further, when a doorway closest to the facility out of doorways of a building including the facility is determined and set to be a recommended doorway, the recommended parking section may be a parking section closest to the recommended doorway.

Further, the in-vehicle navigation device according to the embodiment may further include a parking lot information acquisition unit which acquires parking lot availability information. When the information indicating the absence of a parking space in the recommended parking section is acquired via the parking lot information acquisition unit, the control unit may determine a parking section located next to the recommended parking section to be a new recommended parking section. Further, when a doorway closest to the facility out of doorways of a building including the facility is determined and set to be a recommended doorway, a doorway the next closest to the facility after the recommended doorway may be determined and set to be a new recommended doorway, and the new recommended parking section may be a parking section closest to the new recommended doorway.

According to an exemplary embodiment of the in-vehicle navigation device, in the route guidance in which the destination is set to a facility in a shopping mall including a plurality of facilities such as shops, a vehicle may be guided to a parking section closest to the facility out of a plurality of divided sections of a parking lot in the shopping mall. The recommended parking section is displayed in a different display manner from the display manner of the other parking sections with the use of a different color, for example, such that a user can recognize the recommended parking section at a glance. Further, if the vehicle has entered and left the recommended parking section, the driver may be informed of the departure of the vehicle from the recommended parking section. Further, if the parking section closest to the intended facility does not have a parking space, the vehicle may be guided to a parking section second closest to the intended facility.

With the above-described configuration, the vehicle can be prevented from leaving far away from the intended facility when moving around in the large parking lot of the shopping mall in search for a parking space.

Further, according to another exemplary embodiment, a parking space guiding method performed by the in-vehicle navigation device according to the above-described embodiment may be provided. The parking space guiding method according to this embodiment is performed by an in-vehicle navigation device which searches for a route to a destination in a shopping mall on the basis of map data. The parking space guiding method may include: a step of detecting, when the destination is set to a facility in the shopping mall, a parking section close to the facility as a recommended parking section; a step of displaying, when a vehicle is determined to have entered the site of the shopping mall, a detailed map of the shopping mall, and displaying the recommended parking section in a different manner from the manner in which the other parking sections are displayed; and a step of providing, when the vehicle is determined to have entered and left the recommended parking section, guidance advising the return of the vehicle to the recommended parking section.

### BRIEF DESCRIPTION OF THE DRAWINGS

FIG. 1 is a block diagram illustrating a configuration of an in-vehicle navigation device according to an exemplary embodiment;

FIG. 2 is a flowchart illustrating an example of a parking space guiding process performed by the in-vehicle navigation device of FIG. 1;

FIG. 3 is a diagram illustrating an exemplary example of the data configuration of map data of a shopping mall;

FIGS. 4A and 4B are diagrams illustrating a detailed map of the shopping mall and an example of a recommended parking block;

FIG. 5 is a flowchart illustrating an example of a parking space guiding process performed by the in-vehicle navigation device of FIG. 1, in which parking availability information is taken into account; and

FIG. 6 is a flowchart illustrating an example of a process of re-detecting the recommended parking block.

### DESCRIPTION OF THE PREFERRED EMBODIMENTS

Exemplary embodiments will be described below with reference to the accompanying drawings.

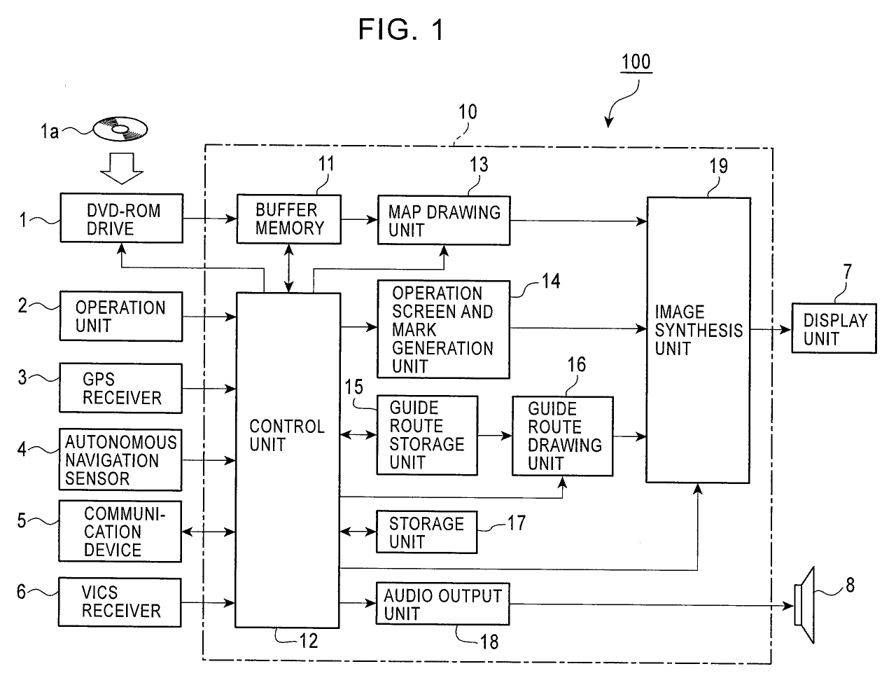

FIG. 1 is a block diagram illustrating a configuration of an in-vehicle navigation device 100 according to a first exemplary embodiment.

In the drawing, the reference numeral 1 represents a DVD-ROM drive, and the reference numeral 1 a represents a storage medium for storing map data and other guide data. As the storage medium for storing such data, a DVD-ROM 1 a is used in the present embodiment. However, a hard disk or another storage medium may be used. A map stored in the storage medium is divided into latitude bands and longitude bands of appropriate sizes in accordance with respective scale levels of 1/12500, 1/25000, 1/50000, and 1/100000, for example. Further, a variety of objects included in the map, such as roads, buildings, facilities, and others, are stored as a set of coordinates of points (nodes) each represented by the latitude and longitude. The map data is formed by, for example, (1) a road layer including a road list, a node table, an intersection constituting node list, and so forth, (2) a background layer for displaying roads, buildings, parks, rivers, and so forth on a map image, (3) a character and symbol layer for displaying characters, map symbols, and so forth indicating the names of administrative districts such as the names of cities, towns, and villages, the names of roads, the names of intersections, and so forth, and (4) a facility layer for displaying facility areas of a predetermined size or larger, such as parking lots. The data of the facility layer includes drawing data (polygon data) including position data of the facility areas and external shape information of the facility areas.

Further, the DVD-ROM 1 a stores, as the map data, road data representing the shapes of the roads used in map matching. The road data is formed by links each connecting a shape node with another shape node. The inter-node distance of the links varies depending on the road shape.

The reference numeral 2 represents an operation unit provided with, for example, an operation button for operating a navigation device body 10. In the present embodiment, the operation unit 2 includes a remote-control transmitter, and a user can operate the navigation device body 10 by using the remote-control transmitter at hand.

The reference numeral 3 represents a GPS receiver which receives a GPS signal transmitted by a plurality of GPS satellites and generates and outputs GPS data including the latitude and longitude representing the current position of a vehicle, the PDOP (Position Dilution of Precision) value, the HDOP (Horizontal Dilution of Precision) value, and so forth. The reference numeral 4 represents an autonomous navigation sensor. The GPS receiver 3 and the autonomous navigation sensor 4 form a position detection unit. The autonomous navigation sensor 4, which is formed by an angle sensor for detecting the vehicle rotation angle, such as a gyroscope, and a travel distance sensor for generating a pulse for each predetermined travel distance, is used to detect the travel speed of the vehicle.

The reference numeral 5 represents a communication device for communicating with a variety of service centers, such as an in-vehicle phone. The reference numeral 6 represents a VICS (Vehicle Information and Communication System) receiver for receiving VICS information transmitted by a radio or optical beacon. The communication device 5 and the VICS receiver 6 form a parking lot information acquisition unit. The beacon is provided along roads and connected to police stations, road administrators, parking lot administrators, and integration centers to provide nearby traffic jam information, parking lot availability information, and so forth.

The reference numeral 7 represents a display unit such as a liquid crystal panel. The navigation device body 10 displays on the display unit 7 a map of the surroundings of the current position of the vehicle, the guide route from the departure point to the destination, a vehicle mark, and other guide information. The reference numeral 8 represents a speaker for providing a user with the guide information in sound.

The navigation device body 10 is formed by the following components. The reference numeral 11 represents a buffer memory for temporarily storing the map data read from the DVD-ROM 1 a via the DVD-ROM drive 1.

The reference numeral 12 represents a control unit formed by a microcomputer. The control unit 12 stores a program for performing a navigation operation. In accordance with the program, the control unit 12 performs a variety of processes, which include the detection of the current position of the vehicle based on a signal received from the GPS receiver 3, the calculation of the travel speed of the vehicle (the vehicle speed) based on a signal generated by the autonomous navigation sensor 4, the reading of the data of a map desired to be displayed from the DVD-ROM 1 a via the DVD-ROM drive 1 into the buffer memory 11, and the search for the guide route from the departure point to the destination based on a set search condition and with the use of the map data read into the buffer memory 11. Further, as described later, if the destination is set to a facility in a shopping mall, the control unit 12 performs such processes as the detection of a doorway closest to the facility out of the doorways of a building including the facility and the detection of a parking section (block) closest to the facility, the search for a guide route to an entrance of the parking block, and the guidance advising the user to park in the parking block.

The reference numeral 13 represents a map drawing unit for generating a map image by using the map data read into the buffer memory 11. The reference numeral 14 represents an operation screen and mark generation unit for generating a variety of menu screens (operation screens) according to the operation state and a variety of marks such as a vehicle position mark and a cursor.

The reference numeral 15 represents a guide route storage unit for storing the guide route searched for and determined by the control unit 12. The reference numeral 16 represents a guide route drawing unit for drawing the guide route. The guide route storage unit 15 stores all nodes of the guide route from the departure point to the destination searched by the control unit 12. In the display of a map, the guide route drawing unit 16 reads the information of the guide route from the guide route storage unit 15, and draws the guide route with a color and a line width different from the color and the line width of the other roads.

The reference numeral 17 represents a storage unit for temporarily storing, for example, detailed information of the shopping mall read from the CD-ROM 1 a and the current position of the vehicle acquired from the signals generated by the GPS receiver 3, the autonomous navigation sensor 4, and so forth. The reference numeral 18 represents an audio output unit for supplying the speaker 8 with an audio signal on the basis of a signal received from the control unit 12.

The reference numeral 19 represents an image synthesis unit for superimposing and displaying, on the map image drawn by the map drawing unit 13 on the display unit 7, the variety of marks and operation screens generated by the operation screen and mark generation unit 14, the guide route drawn by the guide route drawing unit 16, and so forth.

Description will be made of the operations of a parking space guiding process performed by the thus configured in-vehicle navigation device 100 when the destination is set to a facility in a shopping mall.

Upon setting of the destination (a shop in a shopping mall), the control unit 12 of the in-vehicle navigation device 100 searches for a guide route to an entrance of a parking section (referred to also as a parking block) closest to the destination. As the vehicle enters the shopping mall along the guide route, the control unit 12 displays a detailed map of the shopping mall. The control unit 12 further displays the parking block closest to the user-set destination as a recommended parking block such that the recommended parking block is distinguished from the other parking blocks. If the control unit 12 detects that the vehicle has entered and left the recommended parking block, the control unit 12 provides guidance advising the return of the vehicle to the recommended parking block.

In the above-described manner, the in-vehicle navigation device 100 guides the vehicle to the recommended parking block close to the intended facility. Further, if the vehicle which has entered the recommended parking block leaves the parking block, the in-vehicle navigation device 100 notifies the user of the departure of the vehicle from the recommended parking block. Accordingly, it is possible to prevent the vehicle from leaving for a site far from the intended facility.

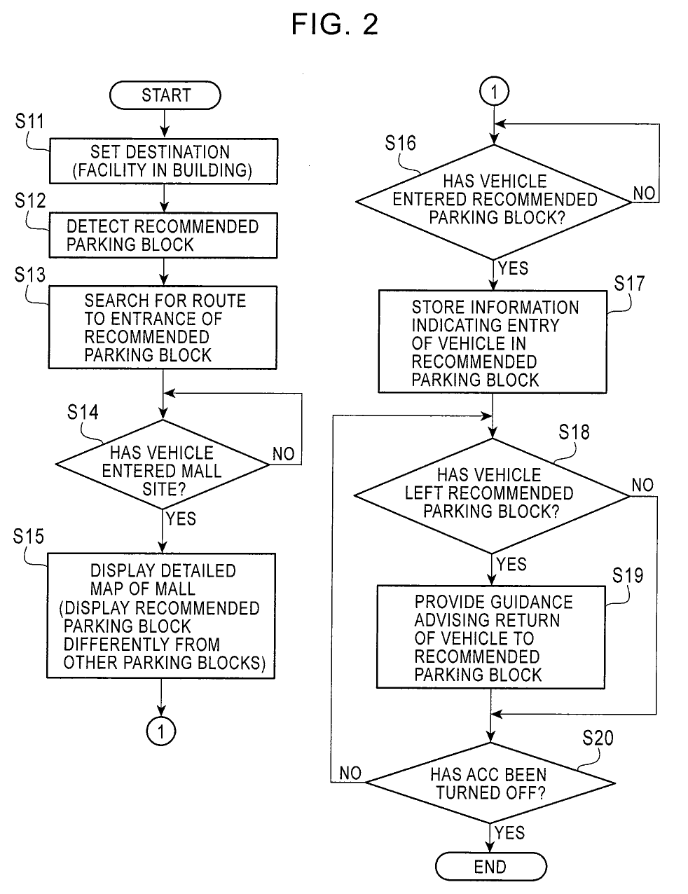

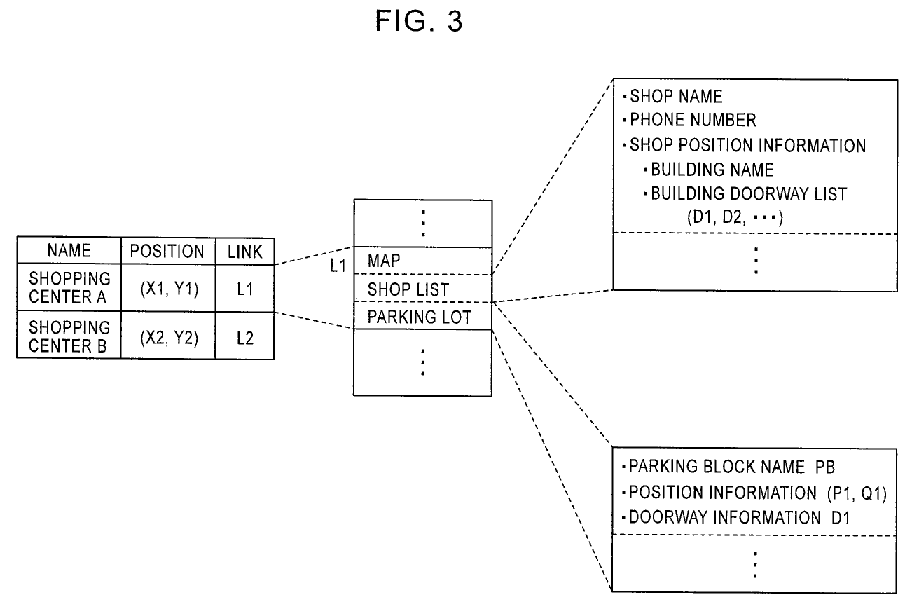

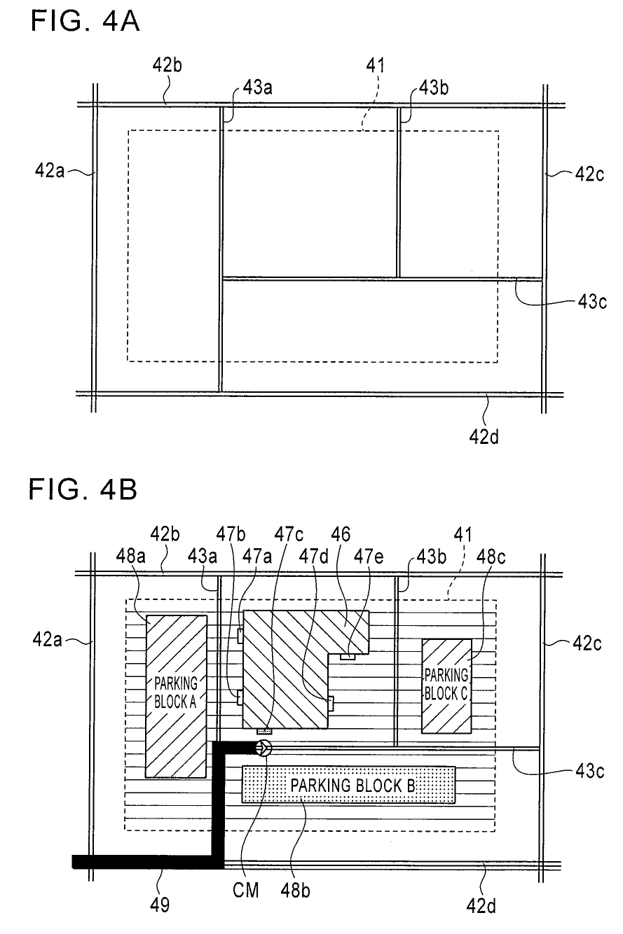

Subsequently, with reference to FIGS. 2 to 4B, detailed description will be made of the parking space guiding process performed by the in-vehicle navigation device 100 according to the present embodiment. FIG. 2 is a flowchart illustrating an example of the parking space guiding process performed in a shopping mall. FIG. 3 is a data configuration diagram of the shopping mall. Further, FIGS. 4A and 4B are diagrams illustrating an example of the display of a map of the shopping mall.

First, at Step S11 of the parking space guiding process illustrated in FIG. 2, a route search condition for searching for the guide route is set. In the setting of the route search condition, a facility in a building of a shopping mall is specified as the destination by the user. The destination is input on the basis of the address, the phone number, the facility name, or the like. Alternatively, the destination may be input by a touch on the destination appearing on a map displayed on a display screen. The specified destination is temporarily stored in the storage unit 17.

At the next Step S12, the recommended parking block is detected on the basis of the destination specified at Step S11. The detection of the recommended parking block is performed with the use of data representing the relationship between the shop in the shopping mall and the doorways of the building including the shop and the relationship between the doorways of the building and the parking blocks.

FIG. 3 is a diagram illustrating an example of the data structure of a shopping mall. As illustrated in FIG. 3, the data structure of a shopping mall is of a hierarchical structure. For example, a shopping center A has a coordinate position (X1, Y1), and the detailed information of the shopping center A is associated with a link L1. In the example of FIG. 3, the detailed information includes the information of the map, the shop list, and the parking lot. In the detailed information, the map information includes building plane figures, parking lots, and mall roads. Further, the shopping list information represents a list of the shops existing in the shopping mall, and stores detailed shop information of each of the shops, e.g., the name, the phone number, and the position information of the shop. The position information of the shop stores the name of the building including the shop and a list of the doorways of the building (D1, D2, . . . ), in which the doorways are arranged in the order of closeness to the shop. Further, the parking lot information represents a list of the parking blocks existing in the shopping mall, and stores detailed information of each of the parking blocks, e.g., the name and the position information of the parking block. The position information of the parking block represents the coordinate position of the parking block (P1, Q1). Doorway information is the information indicating which one of the doorways of the building is closest to the parking block. The example of FIG. 3 shows that D1 is the doorway of the building closest to the parking block PB.

On the basis of the data as illustrated in FIG. 3, which represents the relationship between the shop and the doorways of the building including the shop and the relationship between the doorways of the building and the parking blocks, a doorway closest to the facility set as the destination is extracted and determined to be a recommended doorway. Further, a parking block closest to the recommended doorway is extracted and determined to be a recommended parking block.

At the next Step S13, a route from the current position of the vehicle to an entrance of the recommended parking block detected at Step S12 is searched for. Similarly to the existing technique, the control unit 12 reads the map data from the DVD-ROM 1 a into the buffer memory 11 via the DVD-ROM drive 1. Then, with the use of the map data read into the buffer memory 11 and under the set search condition, the control unit 12 searches for the guide route from the current position of the vehicle to the destination. Herein, the route to the entrance of the recommended parking block is searched for, with the entrance assumed to be the destination. The searched route is stored in the guide route storage unit 15.

At the next Step S14, determination is made on whether or not the vehicle has entered the site of the shopping mall. If the vehicle is determined to have entered the site of the shopping mall, the procedure proceeds to Step S15. If the vehicle has not entered the site of the shopping mall, the entry of the vehicle into the site of the shopping mall is waited for. The entry of the vehicle into the site of the shopping mall is determined on the basis of the position of the vehicle and the map information of the shopping mall. That is, if the position data of the vehicle output by the GPS receiver 3 and the autonomous navigation sensor 4 falls within the range of the site of the shopping mall in a map database, the entry of the vehicle into the site of the shopping mall is detected.

At the next Step S15, the detailed map of the shopping mall is displayed. In a state in which the vehicle has not entered the shopping mall, the entire shopping mall is displayed in a rectangular shape, for example. In the example of FIG. 4A, a shopping mall site 41 is displayed in a rectangular shape inside the area surrounded by general roads 42a to 42d, and roads 43a to 43c extending in the shopping mall site 41 are displayed. FIG. 4B illustrates an example of the detailed map displayed after the entry of the vehicle into the shopping mall. When the vehicle enters the shopping mall site 41, the buildings and the parking blocks in the shopping mall are displayed in detail, and a vehicle position CM and a guide route 49 are displayed on the roads in the shopping mall. As illustrated in FIG. 4B, the detailed map of the shopping mall includes, for example, the plane figure of a building 46 located in the shopping mall, a parking lot including parking blocks 48a to 48c, and the roads 43a to 43c extending into the shopping mall site 41. The building 46 is displayed with doorways 47a to 47e. Further, the parking lot is displayed in the parking blocks, and the names of the parking blocks (e.g., Parking Block A) are also displayed.

The shopping mall site 41, the building 46, the doorways 47a to 47e, and the parking blocks 48a to 48c are respectively displayed in polygons, and are easily viewably displayed with the coordinates of the respective polygons specified for a change in color of the respective areas, for example. Further, in the display of the detailed map of the shopping mall, the recommended parking block is displayed in a different display manner from the display manner of the other parking blocks. Herein, it is assumed that the doorway 47c of the building 46 has been detected as the doorway close to the facility specified as the destination, and that the parking block 48b has been recommended. In this case, as illustrated in FIG. 4B, the recommended parking block 48b is displayed in a different manner from the manner in which the other parking blocks 48a and 48c are displayed (e.g., the recommended parking block 48b is displayed in red, while the other parking blocks 48a and 48c are displayed in green). Further, the doorway 47c close to the destination is also displayed in a different display manner from the display manner of the other doorways 47a, 47b, 47d, and 47e.

After the entry of the vehicle into the shopping mall and the arrival thereof to the set destination, the route guidance is completed, and the display of the guide route 49 is erased. However, the recommended parking block and the recommended building doorway continue to be displayed in the different manner from the other parking blocks and the other doorways, respectively.

At the next Step S16, determination is made on whether or not the vehicle has entered the recommended parking block. The entry of the vehicle into the recommended parking block is waited for, and upon determination that the vehicle has entered the recommended parking block, the procedure proceeds to Step S17. Whether or not the vehicle has entered the recommended parking block is determined on the basis of the detection of whether or not the vehicle position has moved into the recommended parking block represented by polygon data. The detection is performed on the basis of the map data (including the position of the facility area and the polygon data) stored in a map data memory and the position data of the vehicle output by the GPS receiver 3 and the autonomous navigation sensor 4, for example. Further, if the vehicle is installed with a road-to-vehicle communication device, the entry of the vehicle into the recommended parking block may be determined on the basis of whether or not the road-to-vehicle communication device has received a signal from the equipment of the parking lot near the entrance of the recommended parking block.

At the next Step S17, the information indicating that the vehicle has entered the recommended parking block is temporarily stored in the storage unit 17.

At the next Step S18, determination is made on whether or not the vehicle has left the recommended parking block. If the vehicle has left the recommended parking block, the procedure proceeds to Step S19. If the vehicle has not left the recommended parking block, the procedure proceeds to Step S20. Whether or not the vehicle has left the recommended parking block is determined on the basis of the detection of whether or not the vehicle position has moved out of the recommended parking block represented by the polygon data. The detection is performed on the basis of the map data stored in the map data memory and the positional data of the vehicle output by the GPS receiver 3 and the autonomous navigation sensor 4, for example.

At the next Step S19, guidance advising the return to the recommended parking block is provided to the vehicle which has left the recommended parking block. The guidance is provided by sound or by a message displayed on the display screen, which reads, for example, “You have left the parking block B. Please return to the parking block B.”

At the next Step S20, whether or not an ACC (accessory power supply) has been turned off is detected. If the ACC has not been turned off, the procedure returns to Step S18 to continue the present process.

Further, guidance advising the use of the recommended parking block may be provided when the vehicle enters another parking block before entering the recommended parking block. In this case, after it is determined at Step S16 that the vehicle has not entered the recommended parking block, a determination is made on whether or not the vehicle has entered a parking block different from the recommended parking block. Then, if the vehicle is determined to have entered the different parking block, guidance informing that the selected parking block is not the recommended parking block is provided.

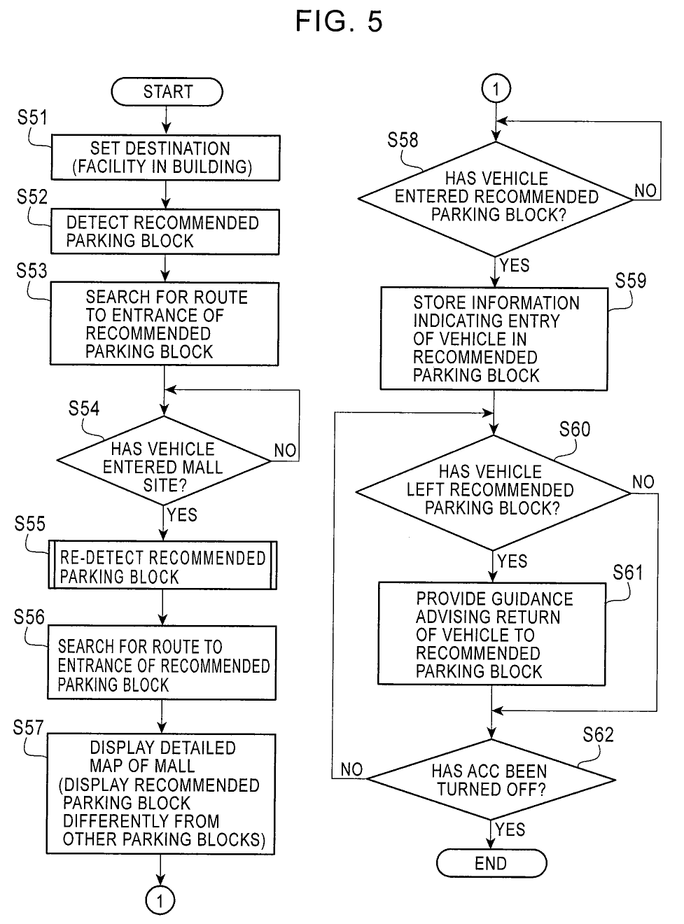

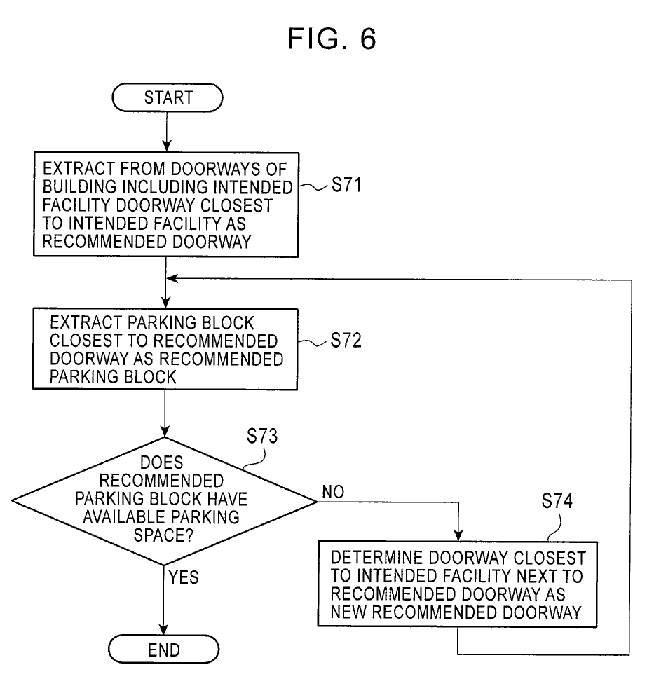

Further, the parking space guidance may be performed such that, if there is no available space in the detected recommended parking block, a parking block in which an available space has been detected is determined to be another recommended parking block. FIGS. 5 and 6 are flowcharts illustrating an example of the parking space guiding process in consideration of the presence or absence of the available space. The flowchart of FIG. 5 is different from the flowchart of FIG. 2 in that the flowchart includes a process of re-detecting the recommended parking block after the entry of the vehicle into the shopping mall site. Steps S11 to S14 of FIG. 2 and Steps S51 to S54 of FIG. 5 are the same. It is assumed at Steps S51 to S54 that the user has set a facility in the shopping mall as the destination, that the recommended parking block suitable for the destination has been detected, and that the vehicle has entered the mall site. On the basis of this assumption, description will be made starting with Step S55.

At Step S55, the re-detection of the recommended parking block is performed. Specifically, the re-detection is performed in accordance with the flowchart illustrated in FIG. 6. Firstly at Step S71 of FIG. 6, out of the doorways of the building including the facility set as the destination, a doorway closest to the facility is extracted from the map data and determined to be the recommended doorway.

At the next Step S72, a parking block closest to the recommended doorway is extracted from the detailed data of the shopping mall stored in the storage unit 17. As illustrated in FIG. 3, the facility in the building of the shopping mall is associated with the doorways of the building, and the doorways of the building are associated with the parking blocks. With the use of this data, a parking block most suitable for using the intended facility is detected, such as via a search or other software algorithm accomplished by a processor (such as the control unit 12 of FIG. 1) using the data.

At the next Step S73, determination is made on whether or not the recommended parking block has a parking space. If the recommended parking block has a parking space, the parking block detected at Step S72 is confirmed as the recommended parking block. Then, the present process is completed, and the procedure proceeds to Step S56 of the parking space guiding process. Meanwhile, if the recommended parking block does not have a parking space, the procedure proceeds to Step S74 to detect the second recommended parking block. The information of the presence or absence of a parking space is transmitted by, for example, a center managing the parking state of the parking lot, and is received via the VICS receiver 6. Further, if the parking lot availability information is provided to the website of the shopping mall by the administrator of the shopping mall, the parking lot availability information may be acquired via the communication device 5.

At Step S74, a doorway closest to the intended facility next to the recommended doorway extracted at Step S71 is determined to be a new recommended doorway. For example, the new recommended doorway may be a doorway that is the next closest to the intended facility after the recommended doorway extracted at Step S71. The extraction of the new recommended doorway also uses the data as illustrated in FIG. 3, which represents the relationship between the facility in the building and the doorways and the relationship between the building of the shopping mall and the parking blocks. As illustrated in FIG. 3, the list of building doorways is stored for each of the facilities (shops) in the building, with the doorways arranged in the order of closeness to the shop. In accordance with this order, the doorway closest to the intended facility next to the recommended doorway (e.g., the doorway D2, if an available space is not found in the parking block corresponding to the selected doorway D1) is determined to be the new recommended doorway. On the basis of the information of the new recommended doorway, the new recommended parking block is detected at Step S72.

After the parking block having an available space is detected by the above-described process, the procedure proceeds to Step S56 to search for a route to an entrance of the recommended parking block and display a new guide route.

The processes of Step S57 and the subsequent steps in FIG. 5 are the same as the processes of Step S15 and the subsequent steps in FIG. 2. That is, after the display of the detailed map of the shopping mall and the entry of the vehicle into the recommended parking block, if the vehicle leaves the recommended parking block, the guidance advising the return of the vehicle to the recommended parking block is provided.

As described above, according to the in-vehicle navigation device of the present embodiment, in the route guidance in which the destination is set to a facility in a shopping mall including a plurality of facilities such as shops, a vehicle is guided to a parking section closest to the facility out of a plurality of divided sections of a parking lot in the shopping mall. The recommended parking section is displayed in a different display manner from the display manner of the other parking sections with the use of a different color, for example, such that a user can recognize the recommended parking section at a glance. Further, if the vehicle has entered and left the recommended parking section, the driver is informed of the departure of the vehicle from the recommended parking section. Further, if the parking section closest to the intended facility does not have a parking space, the vehicle is guided to a parking section second closest to the intended facility.

With the above-described configuration, the vehicle can be prevented from leaving far away from the intended facility when moving around in the large parking lot of the shopping mall in search for a parking space.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An in-vehicle navigation device which searches for a route to a destination and guides a vehicle along the route, the in-vehicle navigation device comprising:
a display unit;
a storage unit which stores detailed map data of a shopping mall;
a position detection unit which detects the current position of the vehicle; and
a control unit which, when the destination is set to a facility in the shopping mall, detects a parking section close to the facility as a recommended parking section, and which, when the vehicle is determined to have entered and subsequently left the recommended parking section on the basis of the current position of the vehicle and the map data, provides, via the display unit, guidance directing the return of the vehicle to the recommended parking section.

2. The in-vehicle navigation device according to claim 1,
wherein, when the vehicle is determined to have entered the site of the shopping mall on the basis of the detected current position of the vehicle and the map data, the control unit displays a detailed map of the shopping mall on a display screen of the display unit, and displays the recommended parking section in a different manner from the manner in which the other parking sections are displayed.

3. The in-vehicle navigation device according to claim 1,
wherein, when a doorway closest to the facility out of a plurality of doorways of a building that includes the facility is determined to be a recommended doorway, the recommended parking section is a parking section closest to the recommended doorway.

4. The in-vehicle navigation device according to claim 1, further comprising:
a parking lot information acquisition unit which acquires parking lot availability information,
wherein, when the information indicating the absence of a parking space in the recommended parking section is acquired via the parking lot information acquisition unit, the control unit determines a parking section that is located next to the recommended parking section and sets the parking section located next to the recommended parking section to be a new recommended parking section.

5. The in-vehicle navigation device according to claim 4,
wherein, when a doorway closest to the facility out of a plurality of doorways of a building that includes the facility is determined to be a recommended doorway, a doorway the next closest to the facility after the recommended doorway is determined to be a new recommended doorway, and the new recommended parking section is a parking section closest to the new recommended doorway.

6. A parking space guiding method performed by an in-vehicle navigation device which searches for a route to a destination in a shopping mall on the basis of map data, the parking space guiding method comprising:
detecting, when the destination is set to a facility in the shopping mall, a parking section closest to the facility from among a plurality of parking sections as a recommended parking section;
displaying, when a vehicle is determined to have entered the site of the shopping mall, a detailed map of the shopping mall, and displaying the recommended parking section in a different manner from the manner in which the other parking sections are displayed; and
providing, when the vehicle is determined to have entered and subsequently left the recommended parking section, guidance directing the return of the vehicle to the recommended parking section.

7. The parking space guiding method according to claim 6,
wherein, when a doorway closest to the facility out of a plurality of doorways of a building that includes the facility is determined and set as a recommended doorway, the recommended parking section is a parking section closest to the recommended doorway.

8. The parking space guiding method according to claim 6, further comprising:
acquiring parking lot availability information; and
displaying, when the information indicating the absence of a parking space in the recommended parking section is acquired, a parking section located next to the recommended parking section as a new recommended parking section.

9. The parking space guiding method according to claim 8, wherein, when a doorway closest to the facility out of a plurality of doorways of a building that includes the facility is determined and set to be a recommended doorway, a doorway the next closest to the facility after the recommended doorway is determined to be a new recommended doorway, and the new recommended parking section is a parking section closest to the new recommended doorway.

10. A parking space guiding method performed by an in-vehicle navigation device which searches for a route to a destination in a shopping mall on the basis of map data, the parking space guiding method comprising:
determining a parking section, from among a plurality of parking sections associated with a shopping mall, that is closest to the destination inside of the shopping mall to be an initial recommended parking section;
receiving information regarding the availability of parking spaces in the plurality of parking sections associated with the shopping mall;
determining whether a parking space in the initial recommended parking section is available based on the information received, and if no parking space is available in the initial recommended parking section, determining a replacement parking section that is the next closest to the destination having an available parking space; and
displaying the replacement parking section on a map of the shopping mall such that a vehicle may be directed to an available parking space that is closest to the destination.

11. The parking space guiding method of claim 10, wherein the replacement parking section is determined as a function of the location of a recommended doorway of the shopping mall.

12. The parking space guiding method of claim 10, the method further comprising determining a doorway from among a plurality of doorways associated with the shopping mall that is the closest to the destination.

13. The parking space guiding method of claim 12, the method further comprising displaying the doorway closest to the destination in a manner that distinguishes the doorway closest to the destination from other doorways associated with the shopping mall.

14. The parking space guiding method of claim 10, the method further comprising displaying the replacement parking section in a manner that distinguishes the replacement parking section from other parking sections associated with the shopping mall.

15. The parking space guiding method of claim 14, the method further comprising displaying and emphasizing, on a map of the shopping mall, a recommended doorway to the shopping mall that is closest to the destination.
